(19) United States
(12) Patent Application Publication
(10) Pub. No.: US 2025/0062501 A1
(43) Pub. Date: Feb. 20, 2025

(54) BATTERY CELL TABS HAVING FEATURES TO FACILITATE ALIGNMENT AND ATTACHMENT

(71) Applicant: GM Global Technology Operations LLC, Detroit, MI (US)

(72) Inventors: Daniel F. Witting, Sterling Heights, MI (US); Teah Kiviste, Windsor (CA)

(21) Appl. No.: 18/451,390

(22) Filed: Aug. 17, 2023

(51) Int. Cl. H01M 50/533; H01M 50/536; H01M 50/54

(52) U.S. Cl. CPC H01M 50/533; H01M 50/536; H01M 50/54; B60L 50/64; H01M 2220/20

(57) ABSTRACT

A battery cell includes a housing enclosing an anode and a cathode, and a first tab in electrical connection with the anode or the cathode. The first tab is made from an electrically conductive material and is configured to provide an electrical connection between the battery cell and an external component, the first tab including a visualization feature configured to visually indicate a position of the first tab when the first tab is underlying another tab.

### INTRODUCTION

The subject disclosure relates to batteries, and more particularly to assembling battery cells.

Battery cells are used in various applications, such as automotive applications (e.g., in electric and hybrid vehicles). For example, electric and hybrid vehicle battery systems include battery modules having multiple battery cells. In some cases, it is desirable to weld or otherwise attach the tabs of multiple cells to improve battery performance.

### SUMMARY

In one exemplary embodiment, a battery cell includes a housing enclosing an anode and a cathode, and a first tab in electrical connection with the anode or the cathode. The first tab is made from an electrically conductive material and is configured to provide an electrical connection between the battery cell and an external component, the first tab including a visualization feature configured to visually indicate a position of the first tab when the first tab is underlying another tab.

In addition to one or more of the features described herein, the visualization feature is a cut-out portion of the first tab, the cut-out portion being a portion of the electrically conductive material removed from the first tab.

In addition to one or more of the features described herein, the visualization feature is a mitered corner of the first tab.

In addition to one or more of the features described herein, the first tab is part of a group of tabs configured to be electrically connected to one another, each tab of the group of tabs including a respective visualization feature configured to uniquely identify each tab.

In addition to one or more of the features described herein, the battery cell is part of a cell group having a plurality of battery cells electrically connected to one another via respective tabs.

In addition to one or more of the features described herein, the respective tabs are configured to be stacked, aligned and joined to electrically connect the plurality of battery cells.

In addition to one or more of the features described herein, the respective tabs each have a visualization feature configured according to a predetermined sequence or pattern of features.

In addition to one or more of the features described herein, the battery cell is part of a battery assembly configured to power an electric motor of a vehicle.

In another exemplary embodiment, a battery assembly includes a battery cell group including a plurality of battery cells, each battery cell of the plurality of battery cells having a tab made from an electrically conductive material and configured to provide an electrical connection between each battery cell and an external component, where the tabs of the plurality of battery cells are electrically connected to and aligned with one another. At least one tab of the plurality of battery cells includes a visualization feature configured to visually indicate a position of the at least one tab when the at least one tab is underlying another tab.

In addition to one or more of the features described herein, the visualization feature is a cut-out portion of the at least one tab, the cut-out portion being a portion of the electrically conductive material removed from the at least one tab.

In addition to one or more of the features described herein, the visualization feature is a mitered corner of the at least one tab.

In addition to one or more of the features described herein, each tab of the plurality of battery cells includes a respective visualization feature configured to uniquely identify each tab.

In addition to one or more of the features described herein, each tab of the plurality of battery cells has a respective visualization feature configured according to a predetermined sequence or pattern of features.

In addition to one or more of the features described herein, the sequence or pattern of features is defined by an array of pre-selected locations, the array of pre-selected locations being the same relative to each tab, and each respective visualization feature is a cut-out portion at a different pre-selected location.

In yet another exemplary embodiment, a method of manufacturing a battery cell group includes acquiring a plurality of battery cells, each battery cell of the plurality of battery cells having a tab made from an electrically conductive material, stacking the tabs of the plurality of battery cells together, and visually inspecting the stacked tabs, where inspecting the stacked tabs includes inspecting a visualization feature of at least one tab to determine whether the stacked tabs are in proper alignment. The method also includes, based on the stacked tabs being in the proper alignment, joining the stacked tabs to provide an electrical connection between each of the plurality of battery cells.

In addition to one or more of the features described herein, the visualization feature is a mitered corner of at least one tab of the plurality of tabs.

In addition to one or more of the features described herein, visually inspecting the stacked tabs includes determining whether the stacked tabs, including at least one tab having a mitered corner, defines a rectangular profile.

In addition to one or more of the features described herein, each tab of the plurality of tabs includes a respective visualization feature, each respective visualization feature configured according to a predetermined sequence or pattern of features.

In addition to one or more of the features described herein, the sequence or pattern of features is defined by an array of pre-selected locations, the array of pre-selected locations being the same relative to each tab, and each respective visualization feature is a cut-out portion at a different pre-selected location.

In addition to one or more of the features described herein, the method further includes assembling the cell group as part of a battery assembly configured to power an electric motor of a vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts an example of a pouch-type battery cell;

FIG. 2 depicts an example of a system for manufacturing battery assemblies;

FIG. 3 depicts a group of cell tabs, one or more of the cell tabs having a visualization feature, in accordance with an exemplary embodiment;

FIG. 4 depicts the group of cell tabs of FIG. 3 in a stacked and folded configuration;

FIGS. 5A and 5B depict a battery cell tab including a sequence used to define visualization features, in accordance with an exemplary embodiment;

FIG. 6 depicts a stack of battery cell tabs including visualization features defined according to the sequence of FIGS. 5A and 5B, in accordance with an exemplary embodiment;

FIGS. 7A-7D depict aspects of a method of manufacturing a battery cell group, in accordance with an exemplary embodiment; and

FIG. 8 depicts a computer system (e.g., an imaging and/or inspection system) in accordance with an embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods, devices and systems are provided for facilitating attachment of battery cell tabs, manufacturing a battery cell group and/or manufacturing a battery assembly. An embodiment of a battery cell tab includes at least one visualization feature that allows for a user or system to view and monitor the alignment of the tab relative to one or more other tabs when attaching a group of tabs together. Such attachment may occur, for example, during a manufacturing or assembly process, where cells are grouped and electrically connected to create a battery assembly (e.g., a cell group and/or battery module).

The visualization feature may include a portion of the cell tab material that is removed, to provide a window or opening that allows the tab to be visualized when the tab is overlaid by another tab. For example, one or more tabs (e.g., an uppermost tab) in a stack of tabs to be joined has a mitered corner that allows a portion of an underlying tab to be seen. In another example, visualization features are unique to each tab, so that individual tabs can be identified when stacked with other tabs.

In electric vehicle battery packs (and batteries for other systems and devices), it can be desirable to weld or otherwise join a group of cells to connect the group of cells in parallel as a cell group. The cell groups are connected in series within a battery module, which increases the capacity of the module and an associated battery pack. Connecting cells in a cell group typically involves stacking and folding the cell tabs and subsequently joining the tabs via ultrasonic welding or other suitable joining technique. It is important that the tabs are properly aligned prior to joining. The visualization features described herein facilitate identifying missing, damaged and/or misaligned tabs.

Embodiments described herein present numerous advantages and technical effects. The embodiments provide for an improved manufacturing process that facilitates proper alignment of cell tabs. Embodiments ensure that tabs are in proper alignment, and thereby avoid performance issues and risks that are associated with improperly oriented cell tabs.

Current methods of electrical inspection can be limited or ineffective when there is sufficient electrical contact between tabs. Methods using visual indications of thickness can be unreliable at the scale thickness of most cell tabs (e.g., microns). Embodiments allow a higher visual gain when looking for defects by using visualization features for inspection.

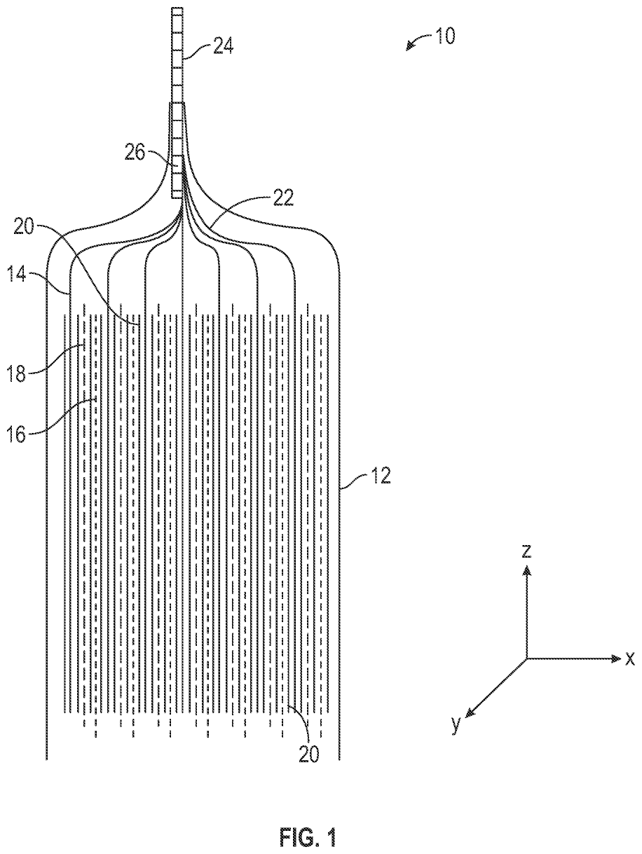

FIG. 1 depicts an example of a battery cell 10 having a tab 24. As described herein, a “tab” refers to any conductive component of a battery cell that allows for electrical connection of the cell to an external component. FIG. 1 shows an example of a tab connected to a pouch-type cell for illustration purposes. Embodiments described herein are not limited to any particular type of battery cell, or any particular shape, size or material of a battery tab. Embodiments may be applicable to prismatic cells and other types of cells. For example, embodiments can be used with prismatic pouch external joints, or internal joints of prismatic or cylindrical can cells.

In this example, the battery cell 10 includes a flexible housing, such as an envelope or pouch 12 that is sealed to enclose a plurality of stacked unit cells (cell stack). The pouch 12 may be an aluminum laminated foil or other suitable pouch material. Each unit cell includes a negative electrode or anode 14, and a positive electrode or cathode 16. The anodes and cathodes are made from selected electrically conductive materials and configured as thin sheets or foils. Each unit cell also includes a separator 18 made from an electrically insulating material such as a polymer or a ceramic. An active material 20, such as a graphite or a material including Lithium, is disposed in the pouch 12 between the various layers of the unit cells.

As shown in FIG. 1, each anode 14 (also referred to as an anode foil) extends away from the unit cells, and the anode foils 14 are attached together as a foil stack 22. The foil stack 22 welds foils together by, for example, a primary ultrasonic weld. The foil stack 22 is in turn attached to an electrically conductive tab 24 via a weld 26. The weld 26 may be a solid-state weld joint formed through ultrasonic welding or a fusion weld joint formed through laser welding, although other metal-to-metal joining procedures may be used. The tab 24 in this example is a negative terminal tab. The cathode foils 16 may be similarly welded to a positive terminal tab (not shown) that extends to an exterior of the pouch 12.

In an embodiment, the tab 24 includes a feature that facilitates identification and/or visual inspection of the tab 24 when another tab is overlayed on the tab 24. The feature may be applied to one or more tabs of a group of overlaid tabs (a “tab stack”). For example, a group of cells can be electrically connected as a cell group. One or more of the cells has a tab with a visualization feature, such that each tab to be joined can be visualized, even though the tab underlies another tab in the cell group. In this way, during a manufacturing or assembly process, each of the group of tabs can be inspected to ensure proper alignment. A visualization feature can also be used to determine if a tab is missing.

It is noted that embodiments described herein are not limited to tabs as shown in FIG. 1. For example, the visualization features and inspection methods can be applied to any suitable component of a battery cell or battery assembly. For example, visualization features are described herein can be applied to various foils to ensure proper alignment when forming foil stacks.

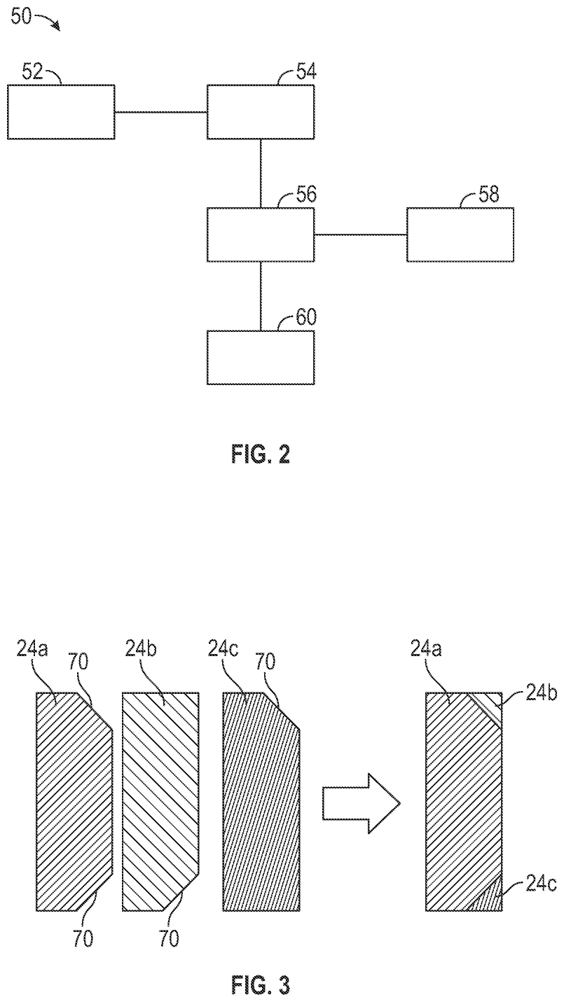

FIG. 2 depicts an example of a manufacturing system 50 for manufacturing a battery assembly. The battery assembly may be a battery module having a plurality of electrically connected battery cells, such as a battery module that is incorporated into a vehicle (e.g., an electric or hybrid vehicle) as part of a battery pack.

In an embodiment, the battery module includes multiple cell groups. A “cell group” is a group of cells that are electrically connected in parallel by joining their respective tabs. The cell groups may be connected in series and assembled in a battery module. In an electric vehicle, multiple battery modules are typically installed in a frame or housing and electrically connected to form a battery pack.

The manufacturing system 50 includes various manufacturing stations, which may be controlled or operated by a computer system, a human operator or a combination thereof. As described herein, a “station” refers to any number, combination and layout of equipment and is not intended to limit the manufacturing system 50 to any specific machine or combination of machines.

The system 50 includes a cell manufacturing station 52 or system, which includes various machines for manufacturing individual cells. For example, for pouch cells, the manufacturing station includes machines for electrode making, winding, forming and heat sealing pouches, filling, vacuum sealing, edge trimming and others. It is noted that the system 50, instead of including cell manufacturing, can receive previously constructed cells.

The manufacturing system 50 includes various stations and equipment for constructing or assembling battery cells into battery assemblies, such as cell groups, modules and battery packs. An example of the manufacturing system 50 includes a cleaning and inspection station 54, a cell preparation station 56, a stacking station 58, a grouping station 60, and/or other stations and equipment.

For example, the cell preparation station 56 includes cutting equipment, such as a laser cutting machine or punch press, for cutting or trimming cell tabs to facilitate tab connections (e.g., by conforming tabs in a planned group to the same geometry for welding). The cutting equipment may also be configured to cut out visualization features from one or more tabs. The cell preparation station 56 may also be used to bend cell tabs to facilitate later electrical connection when constructing a cell group.

Battery cells (including one or more cells having tabs with visualization features) are then transferred to the stacking station 58, where a plurality of cells are stacked together and secured within a module housing to construct a battery module. The battery module is then provided to the grouping station 60, where battery cell tabs are aligned and welded (or otherwise joined) together to form cell groups. Upon completion, each battery module may be further assembled into a battery pack or battery system for an electric vehicle.

Prior to joining, the aligned tabs (tab stack) may be visually inspected to ensure proper alignment. Visual inspection includes inspecting visualization features to ensure that each tab is visible and properly positioned.

It is noted that the manufacturing system 50 is discussed for illustration purposes, and embodiments described herein are not limited to any particular manufacturing process. Any suitable manufacturing system or process that includes some form of cell tab stacking may be used.

Battery cell tabs may be joined in any suitable manner, such that an electrical connection is achieved. Examples of joining methods include various welding techniques, such as ultrasonic welding, resistance welding (e.g., resistance spot welding or RSW), laser welding and others.

An embodiment of a battery cell includes a battery cell tab (e.g., the tab 24) that includes one or more features that allow for visual inspection of a portion of the tab when the tab is underlying another tab. A feature of the tab that allows for such visual inspection is referred to as a “visualization feature.”

A visualization feature may take any suitable form, such that when another tab is overlaid on a tab, the visualization feature allows for an operator or machine (e.g., imaging device) to see a portion of the underlying tab. This allows the operator or machine to easily and quickly determine whether the underlying tab is properly positioned or aligned.

FIGS. 3-6 depict embodiments of battery cell tabs and show various forms of visualization features.

FIG. 3 depicts an embodiment of visualization features applied to a group of tabs 24 (denoted as tabs 24a, 24b and 24c). In this embodiment, the visualization features are mitered or beveled corners, formed by removing a portion of tab material proximate to a corner of a tab. Although three cell tabs are shown, the embodiment may include any number of cell tabs.

Each tab 24 has a different visualization feature configuration, so that a portion of each tab 24a, 24b and 24c is visible when the tabs are stacked. For example, the uppermost (top) tab 24a has two mitered corners 70 (i.e., a mitered corner at each side of the tab 24a). The middle tab 24b has a mitered corner 70 at one side of the tab 24b, and the lowermost (bottom) tab 24c has a mitered corner 70 at an opposing side (opposite the side of the mitered corner of tab 24b).

As shown in FIG. 3, the mitered corners 70 provide visibility of all three tabs 24a, 24b and 24c in the folded position, allowing for detection of processing errors (e.g., missing or crushed tabs).

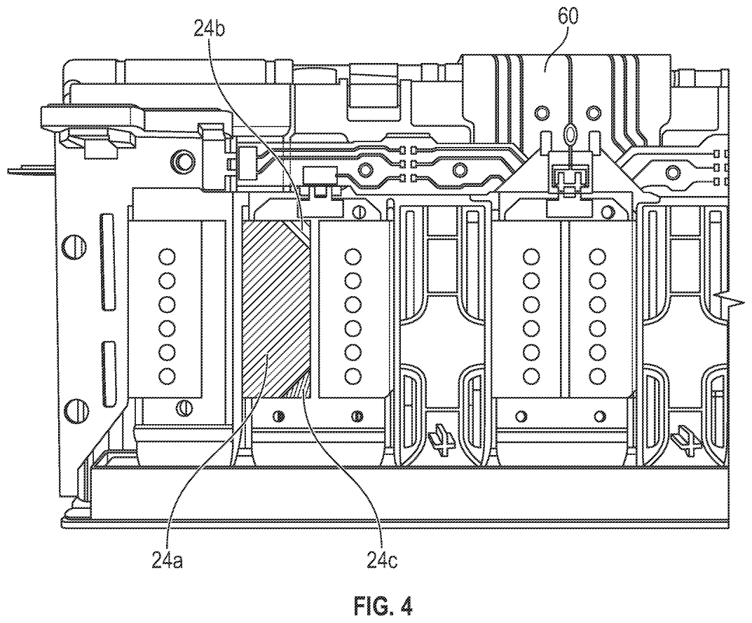

FIG. 4 shows the stacked and folded tabs 24a, 24b and 24c for a group of three cells, and demonstrates how each cell tab in a tab stack is sufficiently visible so that a misalignment can be detected. As shown, when the tabs are folded over, the tabs 24b and 24c are detectable within a rectangular profile.

The tab stack can be inspected to detect any misalignment or defects. For example, if a corner of the profile is mitered or the profile is not completely rectangular, an operator or imaging system can detect that tab 24b or 24c is improperly positioned. As such, inclusion of visualization features improves both quality control and speed of a manufacturing process.

A visualization feature may have any suitable size, shape or pattern. For example, different tabs may include differently shaped cutouts so that each tab can be individually identified. Examples include sawtooth cutouts, square wave cutouts, sinusoidal cutouts and hole patterns (including circular or other shaped holes).

In an embodiment, visualization features are applied to one or more cell tabs in order to uniquely identify each tab in a group of overlaid tabs. For example, a visualization feature is applied to each tab of a group of tabs according to a pre-defined pattern or sequence. The pattern or sequence may be a sequence of locations in an area corresponding to an area of each tab, where the visualization feature is applied at a different location for each tab.

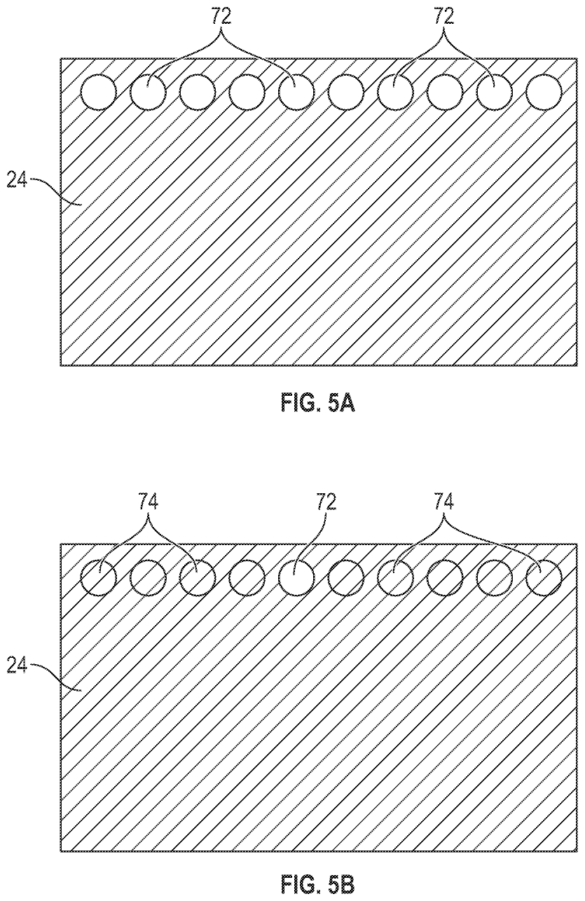

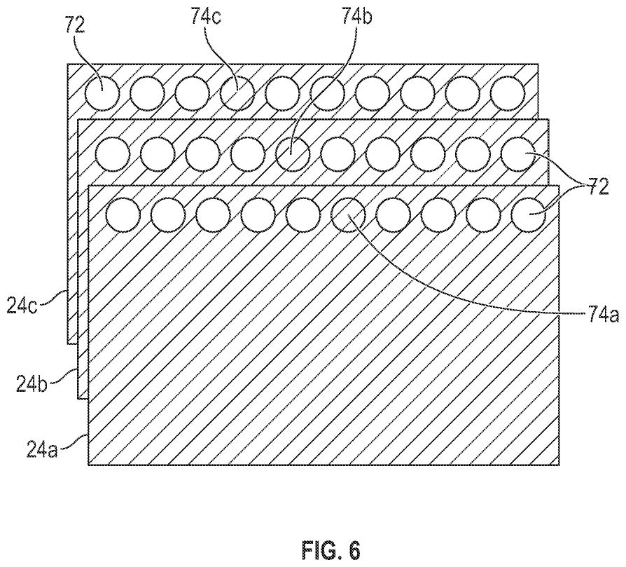

FIGS. 5A, 5B and 6 depict examples of cell tab visualization features. FIGS. 5A and 5B show the tab 24 with features that are used to create a visualization feature 70 configured according to a pattern or sequence of cut-outs. FIG. 5A shows the pattern as a linear series of cut-outs 72 (regions where the tab material has been removed). Although the cut-outs 72 are shown as circular, they can have any suitable shape or size. In addition, although the cut-outs 72 are shown as arrayed along a top section of the tab 24, the cut-outs can be positioned or arrayed in any direction.

FIG. 5B shows the tab 24 in a state where one of the cut-outs 72 has been formed by punching or otherwise removing material at one of the locations in the sequence (denoted as cut-out locations 74). A visualization feature can be created by forming a cut-out 72 at each location 74, except for a selected location. In this example, the cut-out 72 forms a unique visualization feature.

FIG. 6 shows the group of tabs 24a, 24b and 24c with examples of visualization features formed according to a predetermined sequence or pattern. In this example, the visualization feature of each tab is formed by providing the sequence of cut-outs 72 on each tab, and leaving a different location 74 intact. As shown, the tab 24a has a visualization feature in the form of an intact location 74a, the tab 24b has a visualization feature in the form of an intact location 74b, and the tab 24c has a visualization feature in the form of an intact location 74c. Each intact location is different, and may correspond to a predetermined location in the sequence.

A tab stack, such as the tab stack formed by the tabs 24a, 24b and 24c, can be inspected after stacking to ensure proper alignment before welding or otherwise joining the tabs. For example, when tabs 24a-c of FIG. 6 are stacked and aligned, the intact locations 74a, 74c and 74c should be arrayed along the top of the tab stack, such that a specific pattern of intact locations can be seen. If a visualization feature is not seen (e.g., one of the tabs is missing, such that a hole is seen where an intact location 74 should be), or is seen at an unexpected location, the tabs 24a-24c are not properly aligned. Improper alignment can be detected in this way.

A battery cell tab may include one or more visual indicators that facilitate inspection of cell tabs when stacked. A visual indicator may be a color, a marking (e.g., symbol, numerical indicator and/or textual indicator) or any other visual feature that allow for identification of individual tabs. A tab may include a visual indicator at one location or multiple locations on the tab, such that the visual indicator is visible when stacking.

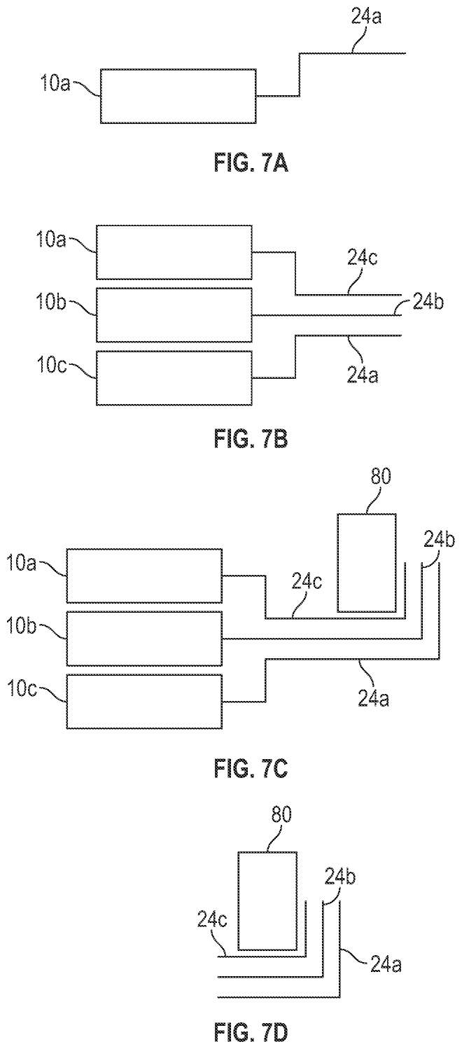

FIGS. 7A-7D depict stages of manufacture of a cell group, and depict aspects of an example of processes performed during manufacturing. These processes may be performed by one or more stations of the manufacturing system 50, or performed using any suitable equipment.

FIG. 7A shows the battery cell 10 (denoted as cell 10a) after the tab 24 (denoted as tab 24a) was trimmed, and after the tab 24a is bent to accommodate subsequent joining of tabs of a group of cells. FIG. 7B shows a group of cells 10 (denoted as cells 10a, 10b and 10c), each having a respective tab 24 (denoted as tabs 24a, 24b and 24c). As shown, tabs 24a and 24c were bent, so that the tabs 24a-24c can be stacked and joined.

As shown in FIG. 7C, the cell tabs 24a-24c are bent or folded to conform to a busbar 80, and are prepared for welding. To join the tabs, the folded tabs are clamped to the busbar 80 to flatten the cells as shown in FIG. 7D, and are then welded together.

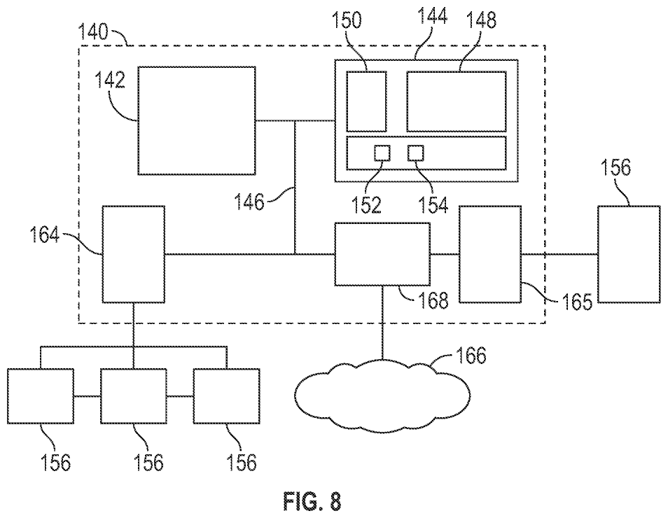

FIG. 8 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module or modules 152 may be included to perform functions related to forming visualization features (e.g., a laser cutting control system). An inspection module 154 may be included for imaging and inspecting battery cell tabs and stacks. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery cell, comprising:
a housing enclosing an anode and a cathode; and
a first tab in electrical connection with the anode or the cathode, the first tab made from an electrically conductive material and configured to provide an electrical connection between the battery cell and an external component, the first tab including a visualization feature configured to visually indicate a position of the first tab when the first tab is underlying another tab.

2. The battery cell of claim 1, wherein the visualization feature is a cut-out portion of the first tab, the cut-out portion being a portion of the electrically conductive material removed from the first tab.

3. The battery cell of claim 2, wherein the visualization feature is a mitered corner of the first tab.

4. The battery cell of claim 1, wherein the first tab is part of a group of tabs configured to be electrically connected to one another, each tab of the group of tabs including a respective visualization feature configured to uniquely identify each tab.

5. The battery cell of claim 1, wherein the battery cell is part of a cell group having a plurality of battery cells electrically connected to one another via respective tabs.

6. The battery cell of claim 5, wherein the respective tabs are configured to be stacked, aligned and joined to electrically connect the plurality of battery cells.

7. The battery cell of claim 6, wherein the respective tabs each have a visualization feature configured according to a predetermined sequence or pattern of features.

8. The battery cell of claim 1, wherein the battery cell is part of a battery assembly configured to power an electric motor of a vehicle.

9. A battery assembly, comprising
a battery cell group including a plurality of battery cells, each battery cell of the plurality of battery cells having a tab made from an electrically conductive material and configured to provide an electrical connection between each battery cell and an external component, wherein the tabs of the plurality of battery cells are electrically connected to and aligned with one another, and wherein at least one tab of the plurality of battery cells includes a visualization feature configured to visually indicate a position of the at least one tab when the at least one tab is underlying another tab.

10. The battery assembly of claim 9, wherein the visualization feature is a cut-out portion of the at least one tab, the cut-out portion being a portion of the electrically conductive material removed from the at least one tab.

11. The battery assembly of claim 9, wherein the visualization feature is a mitered corner of the at least one tab.

12. The battery assembly of claim 9, wherein each tab of the plurality of battery cells includes a respective visualization feature configured to uniquely identify each tab.

13. The battery assembly of claim 12, wherein each tab of the plurality of battery cells has a respective visualization feature configured according to a predetermined sequence or pattern of features.

14. The battery assembly of claim 13, wherein the sequence or pattern of features is defined by an array of pre-selected locations, the array of pre-selected locations being the same relative to each tab, and each respective visualization feature is a cut-out portion at a different pre-selected location.

15. A method of manufacturing a battery cell group, comprising:
acquiring a plurality of battery cells, each battery cell of the plurality of battery cells having a tab made from an electrically conductive material;
stacking the tabs of the plurality of battery cells together;
visually inspecting the stacked tabs, wherein inspecting the stacked tabs includes inspecting a visualization feature of at least one tab to determine whether the stacked tabs are in proper alignment; and
based on the stacked tabs being in the proper alignment, joining the stacked tabs to provide an electrical connection between each of the plurality of battery cells.

16. The method of claim 15, wherein the visualization feature is a mitered corner of at least one tab of the plurality of tabs.

17. The method of claim 16, wherein visually inspecting the stacked tabs includes determining whether the stacked tabs, including at least one tab having a mitered corner, defines a rectangular profile.

18. The method of claim 15, wherein each tab of the plurality of tabs includes a respective visualization feature, each respective visualization feature configured according to a predetermined sequence or pattern of features.

19. The method of claim 18, wherein the sequence or pattern of features is defined by an array of pre-selected locations, the array of pre-selected locations being the same relative to each tab, and each respective visualization feature is a cut-out portion at a different pre-selected location.

20. The method of claim 15, further comprising assembling the cell group as part of a battery assembly configured to power an electric motor of a vehicle.
